(19) United States
(12) Patent Application Publication
(10) Pub. No.: US 2020/0198226 A1
(43) Pub. Date: Jun. 25, 2020

(54) ADDITIVE MANUFACTURING PROCESS USING AMINES FOR THE POST-HARDENING

(71) Applicant: Covestro Deutschland AG, Leverkusen (DE)

(72) Inventors: Dirk Achten, Leverkusen (DE); Thomas Buesgen, Leverkusen (DE); Christoph Eggert, Köln (DE); Hans-Josef Laas, Odenthal (DE); Florian Johannes Stempfle, Köln (DE); Michael Ludewig, Odenthal (DE)

(21) Appl. No.: 16/621,060

(22) PCT Filed: Jun. 13, 2018
(86) PCT No.: PCT/EP2018/065593

§ 371 Date: Dec. 10, 2019

(30) Foreign Application Priority Data
Jun. 14, 2017 (EP) 17176094.5

(51) Int. Cl. B29C 64/135; B33Y 10/00; B33Y 70/00; C08G 18/72; C08G 18/67; C08G 18/38

(52) U.S. Cl. CPC B29C 64/135; B33Y 10/00; B33Y 70/00; B29K 2075/00; C08G 18/672; C08G 18/3819; C08G 18/72

(57) ABSTRACT

The invention relates to a method for producing an object, comprising the step of producing the object from a construction material by means of an additive manufacturing process, wherein the construction material comprising a polyurethane and/or polyester polyol. The construction material further comprises a polyamine component and during and/or after the production of the object, the construction material is heated to a temperature of ≥50° C. The invention also relates to an object obtained according to the claimed method.

The present invention relates to a method of producing an article, comprising the step of producing the article in an additive manufacturing method from a build material, wherein the build material comprises a polyurethane polymer. The invention likewise relates to an article obtainable by the method of the invention.

Additive manufacturing methods refer to those methods by which articles are built up layer by layer. They therefore differ markedly from other methods of producing articles such as milling or drilling. In the latter methods, an article is processed such that it takes on its final geometry via removal of material.

Additive manufacturing methods use different materials and processing techniques to build up articles layer by layer. In fused deposition modeling (FDM), for example, a thermoplastic wire is liquefied and deposited layer by layer on a movable build platform using a nozzle. Solidification gives rise to a solid article. The nozzle and build platform are controlled on the basis of a CAD drawing of the article. If the geometry of this article is complex, for example with geometric undercuts, support materials additionally have to be printed and, after completion of the article, removed again.

In addition, there exist additive manufacturing methods that utilize thermoplastic powders to build up articles layer by layer. In this case, by means of what is called a coater, thin layers of powder are applied and then selectively melted by means of an energy source. The surrounding powder here supports the component geometry. Complex geometries can thus be manufactured more economically than in the above-described FDM method. Moreover, different articles can be arranged or manufactured in a tightly packed manner in what is called the powder bed. Owing to these advantages, powder-based additive manufacturing methods are among the most economically viable additive manufacturing methods on the market. They are therefore used predominantly by industrial users. Examples of powder-based additive manufacturing methods are what are called selective laser sintering (SLS) or high-speed sintering (HSS). They differ from one another in the method for introducing energy for the selective melting into the plastic. In the laser sintering method, the energy is introduced via a deflected laser beam. In what is called the high-speed sintering (HSS) method (EP 1648686), the energy is introduced via infrared (IR) sources in combination with an IR absorber selectively printed into the powder bed. What is called selective heat sintering (SHS) utilizes the printing unit of a conventional thermal printer in order to selectively melt thermoplastic powders.

A further group of additive manufacturing methods uses free-radically crosslinkable resins which, if appropriate, take on their final strength in the article formed via a second curing mechanism.

Examples of such methods are stereolithography methods and what is called the DLP method, derived therefrom.

In the technical field of coatings, “dual-cure” systems are known, in which the coating material applied in liquid form is first crosslinked by free-radical, for example photochemical, means and then cure further via reactions of NCO groups with suitable co-reactants.

It is an object of the present invention to at least partly overcome at least one disadvantage of the prior art. In addition, it is an object of the invention to provide an additive manufacturing method in which the articles to be produced can be obtained in a very cost-efficient and/or individualized and/or resource-conserving manner.

The object is achieved in accordance with the invention by a method as claimed in claim 1 and an article as claimed in claim 11. Advantageous developments are specified in the subsidiary claims. They may be combined as desired, unless the opposite is unambiguously apparent from the context.

A method of producing an article, comprising the step of producing the article in an additive manufacturing method from a build material, wherein the build material comprises a polyurethane polymer and/or a polyester polymer, has the feature that the build material further comprises a polyamine component and that the build material is heated to a temperature of ≥50° C. during and/or after the production of the article.

The heating of the build material to a temperature of ≥50° C., preferably ≥50° C. to ≤180° C. and more preferably ≥70° C. to ≤170° C. (optionally in the presence of urethanization catalysts and/or transesterification catalysts) results in a chemical reaction in the build material. The urethane groups formed by addition may open reversibly, at least in part, under these conditions, as a result of which free NCO groups are available for reaction with the amino groups of the polyamine component to form urea groups. In this way, the average molecular weight of the polyurethane polymer can be increased. In the case of polyamines with an average functionality of >2, the crosslinking density in the build material can be increased further. When the polyurethane polymer has been formed at least partly from polyester polyols, a further reaction that can also proceed is the opening of the ester bonds and reaction with polyamines to give amides. In this way, it is also possible to achieve post-curing of the build material. The same is true when the build material comprises a polyester polymer.

Catalysts usable in accordance with the invention are those that accelerate the urethanization reaction and also the reverse reaction to give isocyanates and polyols and/or amidation of the urethane bond to give ureas, and/or those that accelerate amidation of ester groups to give amides. Suitable catalysts for the purpose are known to those skilled in the art and may be effective under basic, acidic or neutral pH conditions. In a preferred variant, the transamidation reaction is conducted without the addition of additional catalysts.

The article can be heated for a period of ≥1 minute, preferably ≥5 minutes, more preferably ≥10 minutes to ≤24 hours, preferably ≤8 hours, especially preferably <4 hours.

Suitable amines for the polyamine component are especially aliphatic polyamines having an average amine functionality of ≥2, preferably symmetric aliphatic polyamines having an average amine functionality of ≥2 (linear or alicyclic polyamines having fixed geometries with respect to their cis or trans configurations).

Suitable species for preparation of the polyurethane polymer in the build material are the organic aliphatic, cycloaliphatic, araliphatic and/or aromatic polyisocyanates having at least two isocyanate groups per molecule that are known per se to those skilled in the art, and mixtures thereof. For example, it is possible to use NCO-terminated prepolymers.

NCO-reactive compounds having Zerewitinoff-active hydrogen atoms that can be used for preparation of the polyurethane polymer in the build material may be any compounds known to those skilled in the art that have an average OH or NH functionality of at least 1.5. These may be, for example, low molecular weight diols (for example ethane-1,2-diol, propane-1,3- or -1,2-diol, butane-1,4-diol, pentane-1,5-diol, hexane-1,6-diol), triols (for example glycerol, trimethylolpropane) and tetraols (for example pentaerythritol), short-chain amino alcohols, polyamines, but also higher molecular weight polyhydroxyl compounds such as polyether polyols, polyester polyols, polycarbonate polyols, polysiloxane polyols, polyamines and polyether polyamines, and also polybutadiene polyols.

The NCO groups in the polyurethane polymer of the build material may be partly blocked. In that case, the method of the invention further includes the step of deblocking these NCO groups. After they have been deblocked, they are available for further reactions.

The blocking agent is chosen such that the NCO groups are at least partly deblocked when heated in the method of the invention. Examples of blocking agents are alcohols, lactams, oximes, malonic esters, alkyl acetoacetates, triazoles, phenols, imidazoles, pyrazoles and amines, for example butanone oxime, diisopropylamine, 1,2,4-triazole, dimethyl-1,2,4-triazole, imidazole, diethyl malonate, ethyl acetoacetate, acetone oxime, 3,5-dimethylpyrazole, ε-caprolactam, N-methyl-, N-ethyl-, N-(iso)propyl-, N-n-butyl-, N-isobutyl-, N-tert-butylbenzylamine or 1,1-dimethylbenzylamine, N-alkyl-N-1,1-dimethylmethylphenylamine, adducts of benzylamine onto compounds having activated double bonds such as malonic esters, N,N-dimethylaminopropylbenzylamine and other optionally substituted benzylamines containing tertiary amino groups and/or dibenzylamine, or any desired mixtures of these blocking agents.

Suitable polyester polymers can be prepared, for example, from dicarboxylic acids having 2 to 12 carbon atoms, preferably 4 to 6 carbon atoms, and polyhydric alcohols. Examples of useful dicarboxylic acids include: aliphatic dicarboxylic acids such as succinic acid, glutaric acid, adipic acid, suberic acid, azelaic acid and sebacic acid, or aromatic dicarboxylic acids such as phthalic acid, isophthalic acid and terephthalic acid. The dicarboxylic acids can be used individually or as mixtures, for example in the form of a succinic acid, glutaric acid and adipic acid mixture. For preparation of the polyester polymers, it may in some cases be advantageous to use, rather than the dicarboxylic acids, the corresponding dicarboxylic acid derivatives such as carboxylic diesters having 1 to 4 carbon atoms in the alcohol radical, carboxylic anhydrides or carbonyl chlorides. Examples of polyhydric alcohols include glycols having 2 to 10, preferably 2 to 6, carbon atoms, for example ethylene glycol, diethylene glycol, butane-1,4-diol, pentane-1,5-diol, hexane-1,6-diol, decane-1,10-diol, 2,2-dimethylpropane-1,3-diol, propane-1,3-diol or dipropylene glycol. Depending on the desired properties, the polyhydric alcohols may be used alone or in admixture with one another. Also suitable are esters of carbonic acid with the diols mentioned, especially those having 4 to 6 carbon atoms, such as butane-1,4-diol or hexane-1,6-diol, condensation products of w-hydroxycarboxylic acids such as w-hydroxycaproic acid, or polymerization products of lactones, for example optionally substituted w-caprolactone. Polyester polymers used with preference are ethanediol polyadipates, butane-1,4-diol polyadipates, ethanediol butane-1,4-diol polyadipates, hexane-1,6-diol neopentyl glycol polyadipates, hexane-1,6-diol butane-1,4-diol polyadipates and polycaprolactones. The polyester polymers preferably have number-average molecular weights Mn of 450 to 6000 g/mol and can be employed individually or in the form of mixtures with one another.

In a particular embodiment, the build material has a proportion by weight of polyurethane groups (NHCOO) of ≥2%, preferably ≥4%, preferably ≥6%, preferably ≥8%, preferably ≥10% and ≤35%, and/or of ester groups (COO) of ≥2%, preferably ≥4%, preferably ≥6%, preferably ≥8%, preferably ≥10% and ≤30%. The proportion by weight of the polyurethane or polyester groups, based on the total weight of the build material, is determined by means of IR spectroscopy and/or ¹³C NMR spectroscopy.

In a further preferred embodiment, the build material is free-radically crosslinkable and comprises groups having Zerewitinoff-active hydrogen atoms, the article is obtained from a precursor and the method comprises the steps of:
I) depositing free-radically crosslinked build material on a carrier so as to obtain a layer of build material bonded to the carrier and corresponding to a first selected cross section of the precursor;
II) depositing free-radically crosslinked build material onto a previously applied layer of build material so as to obtain another layer of build material corresponding to another selected cross section of the precursor and bonded to the previously applied layer;
III) repeating step II) until the precursor is formed;
   wherein the depositing of free-radically crosslinked build material at least in step II) is effected by exposure and/or irradiation of a selected region of a free-radically crosslinkable build material corresponding to the respectively selected cross section of the precursor and wherein the free-radically crosslinkable build material has a viscosity (23° C., DIN EN ISO 2884-1) of ≥5 mPas to ≤100 000 mPas,
   wherein the free-radically crosslinkable build material comprises a curable component in which there are ester and/or urethane groups and olefinic C═C double bonds
   and step III) is followed by a further step IV):
IV) heating the precursor obtained after step III) to a temperature of ≥50° C. (preferably ≥50° C. to ≤180° C. and more preferably ≥70° C. to ≤170° C.) to obtain the article.

In this variant, the article is thus obtained in two production phases. The first production phase can be regarded as the build phase. This build phase can be implemented by means of ray optics-based additive manufacturing methods such as the inkjet method, stereolithography or the DLP (digital light processing) method and is represented by steps I), II) and III). The second production phase can be regarded as the curing phase and is represented by step IV). The precursor or intermediate article obtained after the build phase is converted here to a more mechanically durable article without any further change in the shape thereof.

Step I) of this variant of the method comprises the depositing of a free-radically crosslinked build material on a support. This is usually the first step in inkjet, stereolithography and DLP methods. In this way, a layer of a build material bonded to the carrier which corresponds to a first selected cross section of the precursor is obtained.

As per the instruction of step III), step II) is repeated until the desired precursor is formed. Step II) comprises depositing a free-radically crosslinked build material on a previously applied layer of the build material to obtain a further layer of the build material which corresponds to a further selected cross section of the precursor and which is joined to the previously applied layer. The previously applied layer of the build material may be the first layer from step I) or a layer from a previous run of step II).

In this method variant, a free-radically crosslinked build material, at least in step II) (preferably also in step I), is deposited by exposure and/or irradiation of a selected region of a free-radically crosslinkable resin corresponding to the respectively selected cross section of the article. This can be achieved either by selective exposure (stereolithography, DLP) of the crosslinkable build material or by selective application of the crosslinkable build material followed by an exposure step which, on account of the preceding selective application of the crosslinkable build material, need no longer be selective (inkjet method).

In the context of this method variant, the terms “free-radically crosslinkable build material” and “free-radically crosslinked build material” are used. The free-radically crosslinkable build material is converted to the free-radically crosslinked build material by the exposure and/or irradiation which triggers free-radical crosslinking reactions. In this context, “exposure” is understood to mean introduction of light in the range between near-IR and near-UV light (wavelengths of 1400 nm to 315 nm). The remaining shorter wavelength ranges are covered by the term “irradiation”, for example far-UV light, x-radiation, gamma radiation and also electron beams.

The respective cross section is appropriately selected by a CAD program with which a model of the article to be produced has been created. This operation is also known as “slicing” and serves as a basis for controlling the exposure and/or irradiation of the free-radically crosslinkable resin.

In this method variant, the free-radically crosslinkable build material has a viscosity (23° C., DIN EN ISO 2884-1) of ≥5 mPas to ≤100 000 mPas. It should thus be regarded as a liquid resin at least for the purposes of additive manufacturing. The viscosity is preferably ≥50 mPas to ≤10 000 mPas, more preferably ≥500 mPas to ≤5000 mPas.

In addition to the curable component, the free-radically crosslinkable build material may also comprise a non-curable component in which for example stabilizers, fillers and the like are combined.

In this variant of the method, in addition, step IV) is also conducted after step III). This step comprises the heating of the precursor obtained after step III) to a temperature of ≥50° C. (preferably ≥50° C. to ≤180° C., more preferably ≥70° C. to ≤170° C.) to obtain the article. The heating can be effected for a period of ≥1 minute, preferably ≥5 minutes, more preferably ≥10 minutes to ≤24 hours, preferably ≤8 hours, especially preferably ≤4 hours.

The reaction is preferably performed until ≤20%, preferably ≤10% and more preferably ≤5% of the amine groups originally present are still present. This can be determined by quantitative IR spectroscopy.

It is further preferable that the reaction of the amino groups with the urethane and/or ester groups leads to an increase in crosslinking density, measured as the increase in storage modulus G′ in the melt of the product (DMA, plate/plate oscillation viscometer to ISO 6721-10 at 20° C. above the glass transition temperature or the melting temperature of the product and at a shear rate of 1/s).

It is further preferable that the reaction products from the reaction of the amine with urethane and/or ester groups leads to cleavage products having a molecular weight of >300 g/mol and further preferably to non-extractable cleavage products to an extent of ≥50% by weight. The molecular weight and the extractable proportion by weight of the cleavage products with typical OH end groups is determined here by extraction with a polar solvent such as acetone and by subsequent determination of molecular weight of the extract by means of gel permeation chromatography.

It is preferable that step IV) is performed only when the entirety of the build material of the precursor has reached its gel point. The gel point is considered to have been reached when, in a dynamic-mechanical analysis (DMA) with a plate/plate oscillation viscometer to ISO 6721-10 at a temperature of >20° C. above the glass transition temperature/melting temperature, the graphs of the storage modulus G′ and the loss modulus G″ intersect. The precursor is optionally subjected to further exposure and/or irradiation to complete free-radical crosslinking. The free-radically crosslinked build material may have a storage modulus G′ (DMA, plate/plate oscillation viscometer according to ISO 6721-10 at a temperature of >20° C. above the glass transition temperature/melting temperature and a shear rate of 1/s) of ≥10⁶ Pa.

The free-radically crosslinkable build material may further comprise additives such as fillers, UV stabilizers, free-radical inhibitors, antioxidants, mold release agents, water scavengers, slip additives, defoamers, flow agents, rheology additives, flame retardants and/or pigments. These auxiliaries and additives, excluding fillers and flame retardants, are typically present in an amount of less than 10% by weight, preferably less than 5% by weight, more preferably up to 3% by weight, based on the free-radically crosslinkable resin. Flame retardants are typically present in amounts of not more than 70% by weight, preferably not more than 50% by weight, more preferably not more than 30% by weight, calculated as the total amount of flame retardants used, based on the total weight of the free-radically crosslinkable build material.

Suitable fillers are, for example, AlOH₃, CaCO₃, metal pigments such as TiO₂ and further known customary fillers. These fillers are preferably used in amounts of not more than 70% by weight, preferably not more than 50% by weight, particularly preferably not more than 30% by weight, calculated as the total amount of fillers used, based on the total weight of the free-radically crosslinkable resin.

Suitable UV stabilizers may preferably be selected from the group consisting of piperidine derivatives, for example 4-benzoyloxy-2,2,6,6-tetramethylpiperidine, 4-benzoyloxy-1,2,2,6,6-pentamethylpiperidine, bis(2,2,6,6-tetramethyl-4-piperidyl) sebacate, bis(1,2,2,6,6-pentamethyl-1-4-piperidinyl) sebacate, bis(2,2,6,6-tetramethyl-4-piperidyl) suberate, bis(2,2,6,6-tetramethyl-4-piperidyl) dodecanedioate; benzophenone derivatives, for example 2,4-dihydroxy-, 2-hydroxy-4-methoxy-, 2-hydroxy-4-octoxy-, 2-hydroxy-4-dodecyloxy- or 2,2′-dihydroxy-4-dodecyloxybenzophenone; benzotriazole derivatives, for example 2-(2H-benzotriazol-2-yl)-4,6-di-tert-pentylphenol, 2-(2H-benzotriazol-2-yl)-6-dodecyl-4-methylphenol, 2-(2H-benzotriazol-2-yl)-4,6-bis(1-methyl-1-phenylethyl)phenol, 2-(5-chloro-2H-benzotriazol-2-yl)-6-(1,1-dimethylethyl)-4-methylphenol, 2-(2H-benzotriazol-2-yl)-4-(1,1,3,3-tetramethylbutyl)phenol, 2-(2H-benzotriazol-2-yl)-6-(1-methyl-1-phenylethyl)-4-(1,1,3,3-tetramethylbutyl)phenol, isooctyl 3-(3-(2H-benzotriazol-2-yl)-5-(1,1-dimethylethyl)-4-hydroxyphenylpropionate), 2-(2H-benzotriazol-2-yl)-4,6-bis(1,1-dimethylethyl)phenol, 2-(2H-benzotriazol-2-yl)-4,6-bis(1-methyl-1-phenylethyl)phenol, 2-(5-chloro-2H-benzotriazol-2-yl)-4,6-bis(1,1-dimethylethyl)phenol; oxalanilides, for example 2-ethyl-2′-ethoxy- or 4-methyl-4′-methoxyoxalanilide; salicylic esters, for example phenyl salicylate, 4-tert-butylphenyl salicylate, 4-tert-octylphenyl salicylate; cinnamic ester derivatives, for example methyl α-cyano-β-methyl-4-methoxycinnamate, butyl α-cyano-β-methyl-4-methoxycinnamate, ethyl α-cyano-β-phenylcinnamate, isooctyl α-cyano-β-phenylcinnamate; and malonic ester derivatives, such as dimethyl 4-methoxybenzylidenemalonate, diethyl 4-methoxybenzylidenemalonate, dimethyl 4-butoxybenzylidenemalonate. These preferred light stabilizers may be used either individually or in any desired combinations with one another.

Particularly preferred UV stabilizers are those which completely absorb radiation having a wavelength <400 nm. These include the recited benzotriazole derivatives for example. Very particularly preferred UV stabilizers are 2-(5-chloro-2H-benzotriazol-2-yl)-6-(1,1-dimethylethyl)-4-methylphenol, 2-(2H-benzotriazol-2-yl)-4-(1,1,3,3-tetramethylbutyl)phenol and/or 2-(5-chloro-2H-benzotriazol-2-yl)-4,6-bis(1,1-dimethylethyl)phenol.

One or more of the UV stabilizers recited by way of example are optionally added to the free-radically crosslinkable build material preferably in amounts of 0.001 to 3.0% by weight, more preferably 0.005 to 2% by weight, calculated as the total amount of UV stabilizers used, based on the total weight of the free-radically crosslinkable build material.

Suitable antioxidants are preferably sterically hindered phenols which may be selected preferably from the group consisting of 2,6-di-tert-butyl-4-methylphenol (ionol), pentaerythritol tetrakis(3-(3,5-di-tert-butyl-4-hydroxyphenyl)propionate), octadecyl 3-(3,5-di-tert-butyl-4-hydroxyphenyl)propionate, triethylene glycol bis(3-tert-butyl-4-hydroxy-5-methylphenyl)propionate, 2,2′-thiobis(4-methyl-6-tert-butylphenol) and 2,2′-thiodiethyl bis[3-(3,5-di-tert-butyl-4-hydroxyphenyl)propionate]. These may be used either individually or in any desired combinations with one another as required. These antioxidants are preferably used in amounts of 0.01% to 3.0% by weight, particularly preferably 0.02% to 2.0% by weight, calculated as the total amount of antioxidants used, based on the total weight of the free-radically crosslinkable build material.

Suitable free-radical inhibitors/retarders are particularly those which specifically inhibit uncontrolled free-radical polymerization of the resin formulation outside the desired (irradiated) region. These are crucial for good contour sharpness and imaging accuracy in the precursor.

Suitable free-radical inhibitors must be chosen according to the desired free-radical yield from the irradiation/exposure step and the polymerization rate and reactivity/selectivity of the double bond carriers. Suitable free-radical inhibitors are, for example, 2,2-(2,5-thiophenediyl)bis(5-tert-butylbenzoxazole), phenothiazine, hydroquinones, hydroquinone ether, quinone alkyds and nitroxyl compounds and mixtures thereof, benzoquinones, copper salts, catechols, cresols, nitrobenzene and oxygen. These antioxidants are preferably used in amounts of 0.001% by weight to 3% by weight.

In a further preferred embodiment, the olefinic double bonds are present in the free-radically crosslinkable build material at least partly in the form of (meth)acrylate groups.

In a further preferred embodiment, the free-radically crosslinkable build material comprises a compound obtainable from the reaction of an NCO-terminated polyisocyanate prepolymer with a molar deficiency, based on the free NCO groups, of a hydroxyalkyl (meth)acrylate.

In a further preferred embodiment, the free-radically crosslinkable build material comprises a compound obtainable from the reaction of an NCO-terminated polyisocyanurate with a molar deficiency, based on the free NCO groups, of a hydroxyalkyl (meth)acrylate.

In a further preferred embodiment, the free-radically crosslinkable build material comprises a compound obtainable from the reaction of an NCO-terminated polyisocyanate prepolymer with a molar excess, based on the free NCO groups, of a hydroxyalkyl (meth)acrylate.

In a further preferred embodiment, the free-radically crosslinkable build material comprises a compound obtainable from the reaction of an NCO-terminated polyisocyanurate with a molar excess, based on the free NCO groups, of a hydroxyalkyl (meth)acrylate.

Suitable polyisocyanates for preparation of the NCO-terminated polyisocyanurates and prepolymers are, for example, those having a molecular weight in the range from 140 to 400 g/mol, having aliphatically, cycloaliphatically, araliphatically and/or aromatically bonded isocyanate groups, for example 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H₁₂MDI), 1,3- and 1,4-bis(isocyanatomethyl)cyclohexane, bis(isocyanatomethyl)norbornane (NBDI), 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane, 1,3-dimethyl-5,7-diisocyanatoadamantane, 1,3- and 1,4-bis(isocyanatomethyl)benzene (xylylene diisocyanate; XDI), 1,3- and 1,4-bis(1-isocyanato-1-methylethyl)benzene (TMXDI) and bis(4-(1-isocyanato-1-methylethyl)phenyl) carbonate, 2,4- and 2,6-diisocyanatotoluene (TDI), 2,4′- and 4,4′-diisocyanatodiphenylmethane (MDI), 1,5-diisocyanatonaphthalene and any desired mixtures of such diisocyanates.

Suitable hydroxyalkyl (meth)acrylates include alkoxyalkyl (meth)acrylates having 2 to 12 carbon atoms in the hydroxyalkyl radical. Preference is given to 2-hydroxyethyl acrylate, the isomer mixture formed on addition of propylene oxide onto acrylic acid, or 4-hydroxybutyl acrylate.

Preference is given to using methacrylates.

The reaction between the hydroxyalkyl (meth)acrylate and the NCO-terminated polyisocyanurate may be catalyzed by the customary urethanization catalysts such as DBTL. The curable compound obtained may have a number-average molecular weight Mₙ of ≥200 g/mol to ≤5000 g/mol. This molecular weight is preferably ≥300 g/mol to ≤4000 g/mol, more preferably ≥400 g/mol to ≤3000 g/mol.

Particular preference is given to a curable compound obtained from the reaction of an NCO-terminated polyisocyanurate with hydroxyethyl (meth)acrylate, wherein the NCO-terminated polyisocyanurate was obtained from hexamethylene 1,6-diisocyanate in the presence of an isocyanate trimerization catalyst. This curable compound has a number-average molecular weight Mₙ of ≥400 g/mol to ≤3000 g/mol. In a further preferred embodiment, the free-radically crosslinkable resin further comprises a free-radical initiator. In order to prevent an unwanted increase in the viscosity of the free-radically crosslinkable resin, free-radical initiators may be added to the resin only immediately before commencement of the method of the invention.

Useful free-radical initiators include thermal and/or photochemical free-radical initiators (photoinitiators). It is also possible to use thermal and photochemical free-radical initiators simultaneously. Suitable thermal free-radical initiators are, for example, azobisisobutyronitrile (AIBN), dibenzoyl peroxide (DBPO), di-tert-butyl peroxide and/or inorganic peroxides such as peroxodisulfates.

In the case of the photoinitiators, a basic distinction is made between two types, the unimolecular type (I) and the bimolecular type (II). Suitable type (I) systems are aromatic ketone compounds, for example benzophenones in combination with tertiary amines, alkylbenzophenones, 4,4′-bis(dimethylamino)benzophenone (Michler's ketone), anthrone and halogenated benzophenones or mixtures of the recited types. Also suitable are type (II) initiators such as benzoin and derivatives thereof, benzil ketals, acylphosphine oxides, 2,4,6-trimethylbenzoyldiphenylphosphine oxide, bisacylphosphine oxides, phenylglyoxylic esters, camphorquinone, α-aminoalkylphenones, α,α-dialkoxyacetophenones and α-hydroxyalkylphenones. Specific examples are Irgacure®500 (a mixture of benzophenone and (1-hydroxycyclohexyl) phenyl ketone, from Ciba, Lampertheim, DE), Irgacure®819 DW (phenylbis(2,4,6-trimethylbenzoyl)phosphine oxide, from Ciba, Lampertheim, DE) or Esacure® KIP EM (oligo-[2-hydroxy-2-methyl-1-[4-(1-methylvinyl)phenyl]propanones], from Lamberti, Aldizzate, Italy) and bis(4-methoxybenzoyl)diethylgermanium. It is also possible to use mixtures of these compounds.

It should be ensured that the photoinitiators have a sufficient reactivity toward the radiation source used. A multitude of photoinitiators are known on the market. Commercially available photoinitiators cover the wavelength range of the entire UV-VIS spectrum. Photoinitiators find use in the production of paints, printing inks and adhesives and also in the dental sector.

In this method variant, the photoinitiator is generally used in a concentration based on the amount of the curable olefinically unsaturated component bearing double bonds used of 0.01% to 6.0% by weight, preferably of 0.05% to 4.0% by weight and more preferably of 0.1% to 3.0% by weight.

In a further preferred embodiment, the method has the following features:
the carrier is arranged within a container and can be lowered vertically in the direction of gravity,
the container contains the free-radically crosslinkable build material in an amount sufficient to cover at least the carrier and an uppermost surface of crosslinked build material deposited on the carrier as viewed in the vertical direction,
before each step II) the carrier is lowered by a predetermined distance so that a layer of the free-radically crosslinkable build material is formed above the uppermost layer of the crosslinked build material as viewed in vertical direction and
in step II) an energy beam exposes and/or irradiates the selected region of the layer of the free-radically crosslinkable build material corresponding to the respectively selected cross section of the precursor.

Thus, this embodiment covers the additive manufacturing method of stereolithography (SLA). The carrier may for example be lowered by a predetermined distance of ≥1 μm to ≤2000 μm in each case.

In a further preferred embodiment, the method has the following features:
the carrier is arranged within a container and can be raised vertically counter to the direction of gravity,
the container provides the free-radically crosslinkable build material,
before each step II) the carrier is lifted by a predetermined distance so that a layer of the free-radically crosslinkable build material is formed below the lowermost layer of the crosslinked build material as viewed in vertical direction and
in step II) a multitude of energy beams simultaneously exposes and/or irradiates the selected region of the layer of the free-radically crosslinkable build material corresponding to the respectively selected cross section of the precursor.

Thus, this embodiment covers the additive manufacturing method of DLP methodology when the multitude of energy beams generates the image to be provided by exposure and/or irradiation via an array of individually actuatable micromirrors. The carrier may be raised, for example, by a predetermined distance of ≥1 μm to ≤2000 μm in each case.

In a further preferred embodiment, the method has the following features:
in step II) the free-radically crosslinkable build material is applied from one or more print heads corresponding to the respectively selected cross section of the precursor and is subsequently exposed and/or irradiated.

Thus, this embodiment covers the additive manufacturing method of the inkjet method: the crosslinkable build material, optionally separately from the catalysts of the invention, is applied selectively via one or more print heads and the subsequent curing by irradiation and/or exposure may be nonselective, for example via a UV lamp. The one or more print heads for application of the crosslinkable build material may be (modified) print heads for inkjet printing methods. The carrier may be configured to be movable away from the print head or the print head may be configured to be movable away from the carrier. The increments of the spacing movements between carrier and the print head may, for example, be within a range from ≥1 μm to ≤2000 μm.
In a further preferred embodiment, the production of the article by means of the additive manufacturing method comprises the steps of:
   applying a layer of particles including the build material to a target surface;
   introducing energy into a selected portion of the layer corresponding to a cross section of the article such that the particles in the selected portion are bonded;
   repeating the steps of applying and introducing energy for a multitude of layers, such that the bonded portions of the adjacent layers become bonded in order to form the article.

This embodiment involves a powder sintering or powder fusion method. It is preferable when at least 90% by weight of the particles have a particle diameter of ≤0.25 mm, preferably ≤0.2 mm, particularly preferably ≤0.15 mm. The energy source for joining the particles may be electromagnetic energy, for example UV to IR light. An electron beam is also conceivable. The bonding of the particles in the irradiated portion of the particle layer is typically effected through (partial) melting of a (semi-)crystalline material and bonding of the material in the course of cooling. Alternatively, it is possible that other transformations of the particles such as a glass transition, i.e. the heating of the material to a temperature above the glass transition temperature, bring about bonding of the particles of the particles to one another.

In a further preferred embodiment, the introducing of energy into a selected portion of the layer corresponding to a cross section of the article such that the particles in the selected portion are bonded comprises the following step:
irradiating a selected portion of the layer corresponding to a cross section of the article with an energy beam to join the particles in the selected portion.

This form of the method can be regarded as a selective sintering method, especially as a selective laser sintering method (SLS). The beam of energy for bonding of the particles may be a beam of electromagnetic energy, for example a “light beam” of UV to IR light. Preferably, the beam of energy is a laser beam, more preferably having a wavelength between 600 nm and 15 μm. The laser may take the form of a semiconductor laser or of a gas laser. An electron beam is also conceivable.

In a further preferred embodiment, the introducing of energy into a selected portion of the layer corresponding to a cross section of the article such that the particles in the selected portion are bonded comprises the following steps:
applying a liquid to a selected portion of the layer corresponding to a cross section of the article, where said liquid increases the absorption of energy in the regions of the layer with which it comes into contact relative to the regions with which it does not come into contact;
irradiating the layer such that the particles in regions of the layer that come into contact with the liquid are bonded to one another and the particles in regions of the layer that do not come into contact with the liquid are not bonded to one another.

In this embodiment, for example, a liquid comprising an IR absorber can be applied to the layer by means of inkjet methods. The irradiation of the layer leads to selective heating of those particles that are in contact with the liquid including the IR absorber. In this way, bonding of the particles can be achieved. Optionally, it is additionally possible to use a second liquid complementary to the energy-absorbing liquid in terms of its characteristics with respect to the energy used. In regions in which the second liquid is applied, the energy used is not absorbed but reflected. The regions beneath the second liquid are thus shaded. In this way, the separation sharpness between regions of the layer that are to be melted and not to be melted can be increased.

In a further preferred embodiment, the production of the article by means of the additive manufacturing method comprises the steps of:
applying a filament of an at least partly molten build material to a carrier, such that a layer of the build material corresponding to a first selected cross section of the article is obtained;
applying a filament of the at least partially molten build material to a previously applied layer of the build material to obtain a further layer of the build material which corresponds to a further selected cross section of the article and which is joined to the previously applied layer;
repeating the step of applying a filament of the at least partially molten build material to a previously applied layer of the build material until the article has been formed.

This embodiment is a melt coating or fused deposition modeling (FDM) method. If the number of repetitions for the applying is sufficiently low, it is also possible to make reference to a two-dimensional article which is to be constructed. Such a two-dimensional article can also be characterized as a coating. For example, for construction thereof, ≥1 to ≤20 repetitions for the application can be conducted.

The individual filaments which are applied may have a diameter of ≥30 μm to ≤2000 μm, preferably ≥40 μm to ≤1000 μm and more preferably ≥50 μm to ≤500 μm.

The first step of this embodiment of the method relates to the building of the first layer on a carrier. Subsequently, the second step, in which further layers are applied to previously applied layers of the build material, is executed until the desired end result in the form of the article is obtained. The at least partly molten build material bonds to existing layers of the material in order to form a structure in z direction. But it is possible that just one layer of the build material is applied to a carrier.

In a further preferred embodiment, the polyamine component has an average number of Zerewitinoff-active H atoms of ≥4.

In a further preferred embodiment, the polyamine component contains one or more compounds from the group of: adipic dihydrazide, ethylenediamine, diethylenetriamine, triethylenetetramine, tetraethylenepentamine, pentaethylenehexamine, dipropylenetriamine, hexamethylenediamine, hydrazine, isophoronediamine, (4,4′- and/or 2,4′-)diaminodicyclohexylmethane, (4,4′- and/or 2,4′-)diamino-3,3′-dimethyldicyclohexylmethane and N-(2-aminoethyl)-2-aminoethanol.

In a further preferred embodiment, the polyamine component is present in a proportion of ≥0.1% by weight to ≤25% by weight, based on the weight of the build material.

In a further preferred embodiment, the polyurethane polymer in the build material has an average molecular weight of the linear repeat units Mᵤ of ≥100 g/mol to ≤2000 g/mol (preferably ≥140 g/mol to ≤800 g/mol, more preferably ≥160 g/mol to ≤600 g/mol and more preferably ≥180 g/mol to ≤500 g/mol), where Mᵤ is calculated as follows:

Mᵤ=((Mᵢ/Rᵢ)+(Mₚ/Rₚ))*200

with:
Mᵢ molecular weight of an NCO group (42 g/mol)
Mₚ molecular weight of an OH group (17 g/mol)
Rᵢ numerical value of the figure for the average NCO group content in % by weight to ISO 11909 of the polyisocyanates used in the build material for preparation of the polyurethane polymer
Rₚ numerical value of the figure for the average OH group content in % by weight to DIN 53240 of the polyols used in the build material for preparation of the polyurethane polymer.

The figures “numerical value of the figure for the average NCO group content in % by weight” and “numerical value of the figure for the average OH group content in % by weight” will be illustrated by the following examples: a polyisocyanate component has an average content of NCO groups of 20% by weight. In that case, Rᵢ in the above formula would have the value of 20. Likewise, if a polyol component has an average content of OH groups of 15% by weight, Rₚ in the above formula would have the value of 15.

In a further preferred embodiment, the polyester polymer in the build material has an average molecular weight of the linear repeat units Mᵤ of ≥100 g/mol to ≤1000 g/mol (preferably ≥120 g/mol to ≤700 g/mol, more preferably ≥150 g/mol to ≤500 g/mol and more preferably ≥160 g/mol to ≤400 g/mol), where Mᵤ is calculated as follows:

Mᵤ=((Mᵢ/Rᵢ)+(Mₚ/Rₚ))*200

with:
Mᵢ molecular weight of an acid group (calculated as 28 g/mol owing to dehydration)
Mₚ molecular weight of an OH group (calculated as 16 g/mol owing to dehydration)
Rᵢ numerical value of the figure for the average acid group content in % by weight, calculable from the titration of the average acid group content in water versus KOH of the polycarboxylic acids used in the build material for preparation of the polyester polymer or their equivalents
Rₚ numerical value of the figure for the average OH group content in % by weight to DIN 53240 of the polyols used in the build material for preparation of the polyester polymer.

The figures “numerical value of the figure for the average acyl group content in % by weight” and “numerical value of the figure for the average OH group content in % by weight” will be illustrated by the following examples: a polycarboxylic acid has an average content of acyl groups of 10% by weight. In that case, Rᵢ in the above formula would have the value of 10. Likewise, if a polyol component has an average content of OH groups of 10% by weight, Rₚ in the above formula would have the value of 10.

The invention further relates to an article obtainable and preferably obtained by a method of the invention.

In a preferred embodiment of the article, the build material heated to a temperature of ≥50° C. during and/or after the production of the article has a urea group content of ≥0.1% by weight to ≤15% by weight (preferably ≥0.3% by weight) to ≤10% by weight and more preferably ≥0.3% by weight and ≤8% by weight) and/or an amide group content of ≥0.1% by weight to ≤10% by weight (preferably ≥0.2% by weight to ≤8% by weight and more preferably ≥0.3% by weight and ≤5% by weight).

The urea and/or amide group content can be determined via IR spectroscopy and/or by titration of the unconverted amine.

In a further preferred embodiment of the article, the build material heated to a temperature of ≥50° C. during and/or after the production of the article has a melting point (DSC) of ≥60° C. (preferably ≥80° C. and more preferably ≥100° C.).

In a further preferred embodiment of the article, the build material heated to a temperature of ≥50° C. during and/or after the production of the article has a different melting point than the build material present before commencement of the method of the invention. The melting point, determined by DSC, is preferably greater than in the starting build material.

In a further preferred embodiment of the article, the build material heated to a temperature of ≥50° C. during and/or after the production of the article has a different modulus of elasticity (ISO 527) than the build material present before commencement of the method of the invention. Preferably, the modulus of elasticity increases in the build material heated to a temperature of ≥50° C. during and/or after the production of the article.

The working examples which follow serve merely to illustrate the invention. They are in no way intended to limit the scope of protection or the claims or the description.

### General Details:

All percentages, unless stated otherwise, are based on percent by weight (% by weight).

The ambient temperature of 23° C. at the time of conducting the experiments is referred to as RT (room temperature).

The methods detailed hereinafter for determining the relevant parameters were employed for performing/evaluating the examples and are also the methods for determining the parameters relevant in accordance with the invention in general.

### Determination of Phase Transitions by DSC

The phase transitions were determined by means of DSC (differential scanning calorimetry) with a Mettler DSC 12E (Mettler Toledo GmbH, Giessen, Germany) in accordance with DIN EN 61006. Calibration was effected via the melt onset temperature of indium and lead. 10 mg of substance were weighed out in standard capsules. The measurement was effected by three heating runs from −50° C. to +200° C. at a heating rate of 20 K/min with subsequent cooling at a cooling rate of 320 K/min. Cooling was effected by means of liquid nitrogen. The purge gas used was nitrogen. The values reported are each based on the evaluation of the 1st heating curve, since changes in the sample in the measurement process at high temperatures are possible in the reactive systems being examined as a result of the thermal stress in the DSC. The melting temperatures Tₘ were obtained from the temperatures at the maxima of the heat flow curves. The glass transition temperature T_{g} was obtained from the temperature at half the height of a glass transition step.

### Determination of Infrared Spectra

The infrared spectra were measured on a Bruker FT-IR spectrometer equipped with an ATR unit.

### Starting Compounds

Polyisocyanate: HDI trimer (NCO functionality >3) with an NCO content of 23.0% by weight from Covestro AG. The viscosity is about 1200 mPa·s at 23° C. (DIN EN ISO 3219/A.3).

| | |
|---|---|
| Hydroxyethyl methacrylate (HEMA) | from Sigma Aldrich |
| Isobornyl methacrylate (IBOMA) | from Sigma Aldrich |
| Hexanediol 1,6-dimethacrylate (HDDMA) | from Sigma Aldrich |
| Isophoronediamine (IPDA) | from Evonik Industries |
| Hexanediol 1,6-diacrylate (HDA) | from Acros Organics |
| Jeffamine T 403 | from Sigma Aldrich |
| Omnirad 1173 | from IGM Resins |

### Formulation of the Build Materials:

In a lidded plastic cup, the components were mixed in the sequence of polyisocyanate, HEMA at 60° C. until it was no longer possible to detect any “free” isocyanate. Free NCO groups were measured using an FT-IR spectrometer (Tensor II) from Bruker. The free NCO groups were measured by placing the sample film in contact with the Platinum ATR unit. The contacted area of the sample was 2×2 mm. In the course of measurement, the IR radiation penetrated 3 to 4 μm into the sample according to wavenumber. An absorption spectrum was then obtained from the sample. In order to compensate for uneven contacting of the samples of different hardness, a baseline correction and a normalization in the wavenumber range of 2600-3200 (CH2, CH3) was performed on all spectra. The interpolation of the “free” NCO group was performed in the wavenumber range of 2170-2380. This gave a numerical value of 0 for the reaction product of polyisocyanate with HEMA used in the experiments.

The free-radically curable build materials according to examples 1 to 8 were mixed in a lidded plastic cup with a Thinky ARE250 planetary mixer at room temperature at a speed of rotation of 2000 revolutions per minute for about 2 minutes. In inventive formulations 2, 3, 4, there was a urethane group concentration of >8%. The amide concentration and urea concentration prior to reaction with the bifunctional amines was <0.1%. Comparative sample 1 was formulated without amine. Comparative samples 5 to 8 had a urethane group concentration <5% and were tested after storage at RT for 24 h, i.e. without heating >50° C.

The free-radically curable build materials according to examples 1 to 8 were applied to a glass plate with a coating bar having a 400 μm gap.

The coated glass substrates were subsequently cured with mercury and gallium radiation sources in a Superfici UV curing line at a belt speed of 5 m/min. The lamp output and belt speed resulted in a radiation intensity of 1300 mJ/cm² acting on the coated substrates.

Subsequently, the UV-cured films on the glass substrates were stored in a drying oven at 100° C. under an air atmosphere for 2 hours.

Martens hardness measurements according to DIN EN ISO 14577 were conducted with a Fischerscope H100C microhardness tester from Fischer. A pyramid-shaped diamond penetrated here into the film surface and the hardness value was determined.

Inventive examples are identified by an *.

| | |
|---|---|
| Jeffamine T 403 | from Sigma Aldrich |
| Omnirad 1173 | from IGM Resins |

### EXAMPLES

| | Example | | | |
|---|---|---|---|---|
| | 1 | 2* | 3* | 4* |
| Feedstocks | Weight [g] | | | |
| Polyisocyanate | 33.8 | 33.8 | 33.8 | 33.8 |
| HEMA | 26.2 | 26.2 | 26.2 | 26.2 |
| IBOMA | 40 | 40 | 40 | 40 |
| IPDA | — | 2.98 | | |
| HDA | — | | 2.03 | |
| Jeffamine 403 | — | | | 5.14 |
| Omnirad 1173 | 3 | 3 | 3 | 3 |

UV curing + oven curing

| | | | | |
|---|---|---|---|---|
| Assessment of film | solid | solid | solid | solid |
| | film | film | film | film |
| HM (Martens hardness | 172 | 146 | 168 | 142 |
| (N/mm²)) | | | | |
| nIT (elastic deformation | 59 | 67 | 66 | 62.9 |
| component %) | | | | |
| Tg first heating [° C.] | 55/127 | 54/116 | 54/118 | 77/119 |
| IR, NH₂ (wagging) signal at | — | — | — | — |
| 810 cm⁻¹ | | | | |

Comparative experiment 1 was conducted without use of an amine and showed the greatest hardness at 172 N/mm². The use of an amine crosslinker in inventive experiments 2 to 4 showed a reduced hardness value and elasticization. This can be explained chemically by the incorporation of the amines into the polymer. In accordance with the functionality and equivalent weights of the amines, moreover, the Tg and the mechanical properties of the product mixture were altered, which can be explained by the formation of urea/amide bonds from existing ester and urethane bonds. The network density can increase or decrease according to the incorporation point.

| | Example | | | |
|---|---|---|---|---|
| | 5 | 6 | 7 | 8 |
| Feedstock | Weight [g] | | | |
| Desmodur ® N | 5.6 | 5.6 | 5.6 | 5.6 |
| 3600 | | | | |
| HEMA | 4.4 | 4.4 | 4.4 | 4.4 |
| IBOMA | 50 | 50 | 50 | 50 |
| HDDMA | 40 | 40 | 40 | 40 |
| IPDA | — | 2.98 | | |
| HDA | — | | 2.03 | |
| Jeffamine 403 | — | | | 5.14 |
| Omnirad 1173 | 3 | 3 | 3 | 3 |

UV curing and storage at RT for 24 h

| | | | | |
|---|---|---|---|---|
| Assessment of | solid film | amine | amine | amine |
| film | | incompletely | incompletely | incompletely |
| | | reacted, | reacted, | reacted, |
| | | tacky film | tacky film | tacky film |
| IR, NH₂ | — | visible | visible | visible |
| (wagging) signal | | | | |
| at 810 cm⁻¹ | | | | |

Further comparative experiments were conducted with mixtures having a urethane density of <5% and storage at room temperature for 24 hours. In the case of comparative film 5 without amine, a solid film was found. In the case of comparative experiments 6, 7 and 8 with variation of the amines, the amine was incompletely incorporated into the film. Unconverted amine was clearly detectable both by the odor and in the infrared spectrum (IR) from the NH vibrations (also called NH wagging or NH₂ wagging), and was manifested in a tacky film consistency.

1. A method of producing an article, comprising:
producing the article in an additive manufacturing method from a build material, wherein the build material comprises a polyurethane polymer, a polyester polymer, or a combination thereof,
wherein the build material further comprises a polyamine component and wherein
the build material is heated to a temperature of ≥50° C. during the production of the article, after the production of the article, or both.

2. The method as claimed in claim 1, wherein the build material is free-radically crosslinkable and comprises groups having Zerewitinoff-active hydrogen atoms, and wherein the method further comprises:
I) depositing free-radically crosslinked build material on a carrier so as to obtain a first layer of build material bonded to the carrier and corresponding to a first selected cross section of the precursor;
II) depositing free-radically crosslinked build material onto the first layer or another previously applied layer of build material so as to obtain another layer of build material corresponding to another selected cross section of the precursor and bonded to the first layer or the previously applied layer;
III) repeating step II) until a precursor is formed;
wherein the depositing of free-radically crosslinked build material at least in step II) comprises exposure and/or irradiation of a selected region of free-radically crosslinkable build material corresponding to the respectively selected cross section of the precursor and
wherein the free-radically crosslinkable build material has a viscosity of ≥5 mPas to ≤100 000 mPas at 23° C. based on DIN EN ISO 2884-1,
wherein the free-radically crosslinkable build material comprises a curable component including ester groups, urethane groups, or a combination thereof and olefinic C═C double bonds
and wherein step III) is followed by a further step IV):
IV) heating the precursor obtained after step III) to a temperature of ≥50° C. to obtain the article.

3. The method as claimed in claim 2, wherein:
the carrier is arranged within a container that is vertically lowerable in the direction of gravity,
the container contains the free-radically crosslinkable build material in an amount sufficient to cover at least the carrier, an uppermost surface of crosslinked build material deposited on the carrier, or a combination thereof as viewed in a vertical direction,
before each step II) the carrier is lowered by a predetermined distance so that a layer of the free-radically crosslinkable build material is formed above an uppermost layer of the crosslinked build material as viewed in the vertical direction and
in step II) an energy beam exposes, irradiates, or a combination thereof the selected region of the layer of the free-radically crosslinkable build material corresponding to the respectively selected cross section of the precursor.

4. The method as claimed in claim 2, wherein:
the carrier is arranged within a container that is vertically raisable counter to the direction of gravity,
the container provides the free-radically crosslinkable build material,
before each step II) the carrier is raised by a predetermined distance so that a layer of the free-radically crosslinkable build material is formed below a lowermost layer of the crosslinked build material as viewed in a vertical direction and
in step II) a multitude of energy beams simultaneously exposes, irradiates, or a combination thereof the selected region of the layer of the free-radically crosslinkable build material corresponding to the respectively selected cross section of the precursor.

5. The method as claimed in claim 2, wherein:
in step II) the free-radically crosslinkable build material is applied from one or more print heads corresponding to the respectively selected cross section of the precursor and then exposed, irradiated, or a combination thereof.

6. The method as claimed in claim 1, wherein the polyamine component has an average number of Zerewitinoff-active hydrogen atoms of ≥2.

7. The method as claimed in claim 1, wherein the polyamine component comprises one or more of: adipic dihydrazide, ethylenediamine, diethylenetriamine, triethylenetetramine, tetraethylenepentamine, pentaethylenehexamine, dipropylenetriamine, hexamethylenediamine, hydrazine, isophoronediamine, (4,4′- and/or 2,4′-)diaminodicyclohexylmethane, (4,4′- and/or 2,4′-)diamino-3,3′-dimethyldicyclohexylmethane and N-(2-aminoethyl)-2-aminoethanol.

8. The method as claimed in claim 1, wherein the polyamine component is present in a proportion of ≥0.1% by weight to ≤20% by weight, based on the weight of the build material.

9. The method as claimed in claim 1, wherein the polyurethane polymer in the build material has an average molecular weight of linear repeat units Mᵤ of ≥100 g/mol to ≤2000 g/mol, where Mᵤ is calculated as follows:
Mᵤ=((Mᵢ/Rᵢ)+(Mₚ/Rₚ))*200
with:
Mᵢ molecular weight of an NCO group
Mₚ molecular weight of an OH group
Rᵢ average NCO group content in % by weight based on a total weight of polyisocyanates used in the build material for preparation of the polyurethane polymer, based on ISO 11909
Rₚ average OH group content in % by weight based on a total weight of polyols used in the build material for preparation of the polyurethane polymer, based on DIN 53240.

10. The method as claimed in claim 1, wherein the polyester polymer in the build material has an average molecular weight of linear repeat units Mᵤ of ≥100 g/mol to ≤1000 g/mol, where Mᵤ is calculated as follows:
Mᵤ=((Mᵢ/Rᵢ)+(Mₚ/Rₚ))*200
with:
Mᵢ molecular weight of an acid group
Mₚ molecular weight of an OH group
Rᵢ average acyl group content in % by weight based on a total weight of polycarboxylic acid used in the build material for preparation of the polyester polymer or their equivalents, based on a titration of the average acid group content in water versus KOH of the polycarboxylic acids
Rₚ average OH group content in % by weight based on a total weight of polyols used in the build material for preparation of the polyester polymer, based on DIN 53240.

11. An article obtainable by the method as claimed in claim 1.

12. The article as claimed in claim 11, wherein the build material has a urea group content of ≥0.1% by weight to ≤15% by weight, an amide group content of ≥0.1% by weight to ≤10% by weight, or both.

13. The article as claimed in claim 11, wherein the build material has a melting point of ≥60° C. based on DSC.

14. The article as claimed in claim 11, wherein the build material has a different melting point than the build material present before commencement of the method of claim 1.

15. The article as claimed in claim 11, wherein the build material has a different modulus of elasticity than the build material present before commencement of the method of the claim 1 based on ISO 527.
